(19) United States
(12) Patent Application Publication
(10) Pub. No.: US 2005/0223748 A1
(43) Pub. Date: Oct. 13, 2005

(54) Method of joining optical fiber preforms and apparatus therefor

(76) Inventors: Donald J. Ames, Campbell, NY (US); Calvin T. Coffey, Watkins Glen, NY (US); Joel T. Sanford, Bath, NY (US)

Correspondence Address: CORNING INCORPORATED, SP-TI-3-1, CORNING, NY, 14831, US

(21) Appl. No.: 10/814,388

(22) Filed: Mar. 30, 2004

(51) Int. Cl. C03C 27/00

(52) U.S. Cl. 65/407; 65/425; 65/501

(57) ABSTRACT

A method of joining optical fiber preforms is disclosed wherein the optical fiber preforms are butt-welded by heating the opposing endfaces of the preforms with a heat source comprising an electric arc formed across a gap between the opposing endfaces, the electric arc being formed between at least two opposing electrodes, and thereafter contacting the opposing endfaces to join the preforms and form an elongated optical fiber preform. The elongated optical fiber preform may then be drawn into an optical fiber. Also disclosed is an apparatus for joining optical fiber preforms, and an optical fiber draw tower including the joining apparatus.

### BACKGROUND OF THE INVENTION

1. Field of the Invention

The present invention relates generally to forming an optical fiber preform, and more particularly to joining optical fiber preforms to form an elongated optical fiber preform.

2. Technical Background

The growth of optical telecommunication and data networks has required the production of optical fiber on an ever increasing scale with greater efficiency and lower cost. Many methods have been explored to make the manufacturing process more efficient. Such methods have included manufacturing larger and larger glass preforms while drawing optical fiber therefrom at increasing rates. Contemporary optical fiber preforms may exceed several inches in diameter. However, because there is a practical limit to both the length and diameter of a single optical fiber preform which can be manufactured, and the rate at which an optical fiber may be drawn therefrom with consistent optical attributes, conventional optical fiber manufacturing processes require intermittent interruptions in the drawing process to replace exhausted optical fiber preforms.

In a typical optical fiber manufacturing process, an optical fiber preform is lowered into a draw furnace and the lower end, or tip, of the preform is placed in a hot zone of the furnace. When the tip of the preform reaches the softening temperature of the glass, the tip pulls away from the preform, creating a neckdown region. By drawing on the neckdown region, an optical fiber may be formed. The drawn optical fiber is cooled, coated and wound onto a take-up spool until the glass comprising the optical fiber preform has been exhausted. At that time, the draw process is halted, and a new preform is inserted into the furnace and the draw process re-started.

Prior art processes of increasing the size, and therefore the amount of optical fiber which may be drawn from a single optical fiber preform have included joining several optical fiber preforms together at their ends, therefore increasing the length of the optical fiber preform. Butt-welding of optical fiber preforms, such as is disclosed in U.S. Pat. No. 6,178,779 or U.S. Pat. No. 6,098,429 has included heating the ends of the preforms with a plasma issuing from a single plasma torch or with one or more lasers. Such techniques are generally applied to optical fiber preforms having small diameters, typically less than about 200 mm. However, when applied to larger optical fiber preforms having diameters on the order of several inches, such methods may suffer from several disadvantages, including relatively low heating temperatures at the end surfaces of the preforms to be welded, and asymmetric heating of the preform ends. A method of joining ceramic articles with an electric arc disclosed in U.S. Pat. No. 4,724,020 requires electrically conductive materials and a combustion burner to preheat the materials.

### SUMMARY

In a broad aspect of the invention, a method of joining optical fiber preforms is proposed comprising aligning first and second optical fiber preforms, the first and second optical fiber preforms each having an opposing endface, forming an electric arc extending between first and second electrodes, the electric arc extending through a gap between the opposing endfaces, and moving the first and second optical fiber preforms together so as to contact the opposing endfaces and join the first and second optical fiber preforms. Preferably, an inert gas is flowed between the first and second electrodes. It is preferable that the first and second electrodes are supplied with an alternating current. Preferably, the alternating current has a square waveform.

In one embodiment of the invention, the method comprises forming a plurality of electric arcs with a plurality of first and second electrodes. Preferably, a first pair of electrodes comprising a first and second electrode are supplied with an alternating current having a frequency one half the frequency of an alternating current supplied to an adjacent pair of electrodes comprising a first and second electrode. Preferably, the alternating current supplied to the first pair of first and second electrodes is phase locked with the alternating current supplied to the second pair of first and second electrodes.

In another broad aspect of the invention, an apparatus for joining optical fiber preforms is disclosed, the apparatus comprising first and second electrodes, the first and second electrodes being spaced apart by a distance of at least about 1 inch. An electrical power supply in electrical communication with the first and second electrodes supplies a current to the first and second electrodes. Preferably, the power supply is capable of delivering an alternating current. The alternating current preferably has a substantially square waveform.

In one embodiment, the apparatus of the present invention comprises a plurality of first and second electrode pairs, each electrode pair comprising a first and second electrode.

In still another broad aspect of the invention, an optical fiber draw tower is proposed wherein the optical fiber draw tower comprises an optical fiber joining apparatus as described supra. Preferably, the joining of the optical fiber preforms is conducted in-situ, i.e. while optical fiber is being drawn from one of the optical fiber preforms being joined.

### BRIEF DESCRIPTION OF THE DRAWINGS

FIG. 1 is a cross sectional view of a portion of an optical fiber joining apparatus according to an embodiment of the present invention showing first and second optical fiber preforms in relation to the first and second electrodes.

FIG. 2 is a cross section of an optical fiber preform showing the core region and the cladding region.

FIG. 3 is a close up view of an exemplary first or second optical fiber preform according to an embodiment of the present invention showing an opposing endface of the preform.

FIG. 4 is a perspective view of an apparatus for joining optical fiber preforms according to an embodiment of the present invention.

FIG. 5 is a top down view of an exemplary carriage assembly according to an embodiment of the present invention.

FIG. 6 is a side view of the apparatus of FIG. 4.

FIG. 7 is a view of a longitudinal cross section of an exemplary electrode according to the present invention illustrating the shape of the tip from which an electric arc issues.

FIG. 8 is a top down view of an opposing endface showing the relationship between the electrodes and the opposing endface, and the counter flowing inert gas streams in accordance with an embodiment of the present invention.

FIG. 9 is a perspective view of an exemplary electrode and electrode holder according to an embodiment of the present invention showing an inert gas nozzle disposed about the electrode.

FIG. 10 is an illustration of an exemplary square waveform which may be supplied by the power supply to the first and second electrodes.

FIG. 11 is a side view of joined first and second optical fiber preforms showing the ridge of glass which may form around a circumference of the preforms at the interface thereof.

FIG. 12 is a top down view illustrating a method of removing the glass ridge which may form around a circumference of the joined optical fiber preforms by smoothing the glass ridge with an electric arc.

FIG. 13 is an illustration of a draw tower according to an embodiment of the present invention.

FIG. 14 is an illustration of an embodiment of the present invention wherein a plurality of electric arcs are formed between a plurality of first and second electrodes.

### DETAILED DESCRIPTION

Detailed references will now be made to the drawings in which examples embodying this invention are shown. The drawings and detailed description provide a full and detailed written description of the invention, and of the manner and process of making and using it, so as to enable one skilled in the pertinent art to make and use it, as well as the best mode of carrying out the invention. However, the examples set forth in the drawings and detailed description are provided by way of explanation of the invention and not meant as a limitation of the invention. This invention thus includes any modifications and variations of the following examples as come within the scope of the appended claims and their equivalents. The detailed description uses numerical and letter designations to refer to features in the drawings. Like or similar designations in the drawings and description have been used to refer to like or similar parts of the invention.

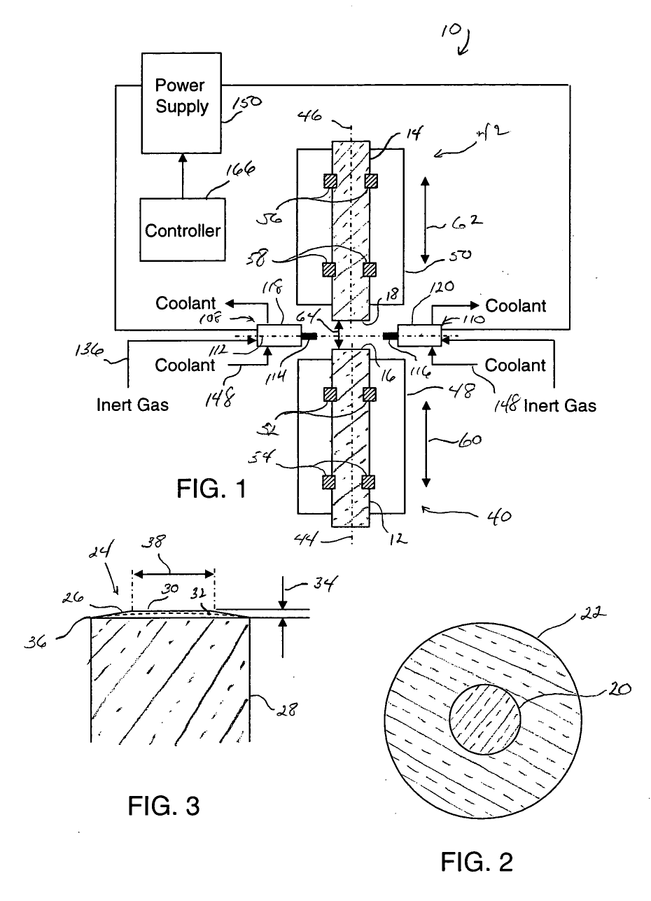

FIG. 1 depicts an embodiment of the present invention comprising an apparatus for joining silica glass optical fiber preforms, generally designated as numeral 10. First optical fiber preform 12 is aligned with second optical fiber preform 14, each of the first and second optical fiber preforms 12 and 14 having an opposing endface 16 and 18 respectively. By optical fiber preform what is meant is an optical fiber precursor comprising at least core glass 20; more preferably the precursor comprises a core glass and at least a portion of the cladding glass 22, as illustrated in FIG. 2. The optical fiber preform may be, for example, a core rod (cane) upon which additional glass will be formed before the optical fiber preform is drawn into an optical fiber, or the optical fiber preform may have no additional glass formed thereon prior to being drawn into an optical fiber. The additional glass may comprise core glass, cladding glass, or both core glass and cladding glass. The cladding glass is typically pure silica but may comprise one or more suitable dopants for raising or lowering the index of refraction of the cladding glass including, but not limited to F or GeO₂. The core may be pure silica or silica doped with one or more suitable dopants for raising or lowering the index of refraction of the core glass, including, but not limited to F, GeO₂ or Cl.

Preferably, at least one opposing endface 16, 18 has a center portion which is raised relative to an outer region of the endface; more preferably both opposing endfaces 16 and 18 have a raised center portion. FIG. 3 is a side view of an exemplary endface which may be used as either or both opposing endfaces 16 and 18. As shown in FIG. 3, endface 24 may be prepared by forming a bevel 26 around a circumference of optical fiber preform 28 at endface 24 while retaining a flat portion 30 within a center portion of the endface. Alternatively, endface 24 may have a convex or hemispherical shape as indicated by the dotted line 32. The skilled artisan will realize that any number of opposing endface shapes are possible, and a convex, hemispherical, or generally conical shape, wherein a maximum height 34 of the center region above a circumferential edge 36, as indicated in FIG. 3, is not intended to be limiting in this regard. For an optical fiber preform having a diameter of approximately 2.4 inches (6.1 cm), a center region height 34 of about 0.05 inches (0.13 cm) and a flat diameter 38 of about 0.35 inches (0.89 cm) has been found to be satisfactory for an endface having a beveled edge.

In the embodiment shown in FIG. 1, first and second optical fiber preforms 12, 14 are mounted on first and second carriage assemblies 40 and 42, respectively, the carriage assemblies being operable to translate first and second optical fiber preforms 12, 14 in a direction parallel to the longitudinal axis 44 of first optical fiber preform 12. For the purposes of further discussion, reference will be made to the longitudinal axis 44 of first optical fiber preform 12, but it will be recognized by one skilled in the art that reference could easily be made to the longitudinal axis 46 of second optical fiber preform 14. Preferably, longitudinal axis 44 of first optical fiber preform 12 is aligned to longitudinal axis 46 of second optical fiber preform 14 such that first and second optical fiber perform longitudinal axes 44 and 46 form a single common longitudinal axis. Carriage assemblies 40 and 42 comprise carriages 48 and 50 respectively, and clamping member pairs 52, 54, 56, and 58 for clamping onto first and second optical fiber preforms 12 and 14. In the embodiment shown in FIG. 1, for example, carriage assembly 40 comprises carriage 48 and clamping member pairs 52 and 54. Carriage assembly 42 comprises carriage 50 and clamping member pairs 56 and 58.

First and second carriage assemblies 40, 42 are preferably capable of moving separately or in unison with one another, and in both directions parallel to longitudinal axis 44 of first optical fiber preform 12 (or alternatively axis 46 of second optical fiber preform 14) as indicated by arrows 60 and 62. Either second optical fiber preform 14 is translated by second optical fiber carriage assembly 42 in a direction parallel to longitudinal axis 44 wherein gap 64 remains between opposing endfaces 16 and 18, or first optical fiber preform 12 may be similarly translated to form gap 64. Alternatively, both optical fiber preform 12 and 14 may be translated along an axis parallel to axis 44 to form gap 64.

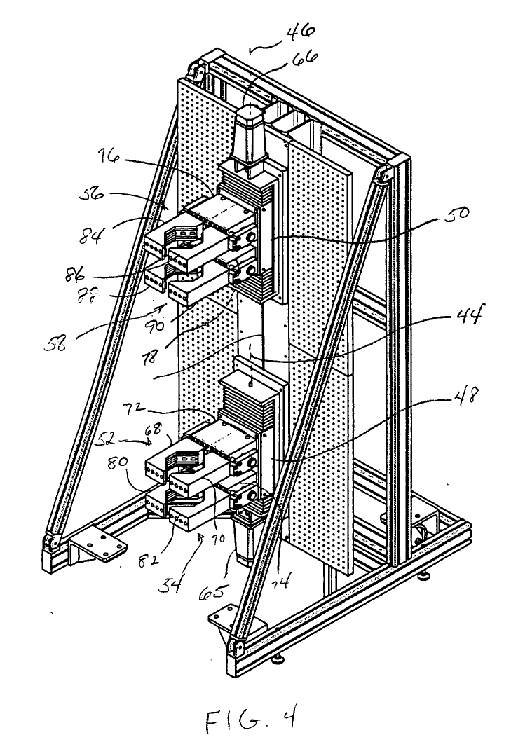

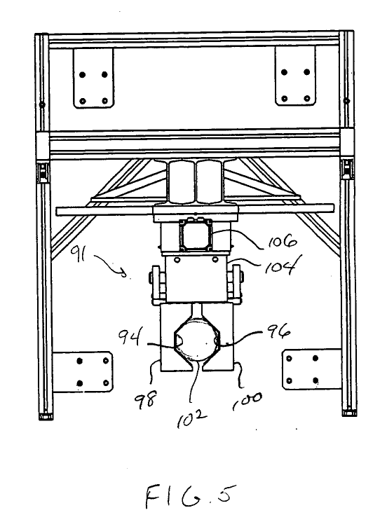

A detailed perspective view of the embodiment of first and second carriage assemblies depicted in FIG. 1 is illustrated in FIG. 4. As shown in the figure, first and second carriages 40, 42 are driven along axis 44 by motors 65 and 66, respectively. Motors 65 and 66 may be connected to carriages 48 and 50, for example, by lead screws. Clamping member pair 52 is comprised of two opposing jaw members 68 and 70 which are attached to actuator 72. Actuator 72 closes or opens jaw members 68 and 70 by simultaneously moving the jaws toward or away from each other in a direction orthagonal to axis 44. Clamping member pairs 54, 56 and 58 operate in a similar manner to clamping member pair 52 wherein the operation of actuators 74, 76 and 78 opens or closes jaw members 80 and 82, jaw members 84 and 86, or jaw members 88 and 90, respectively. Clamping member pairs 52, 54, 56 and 58 may be operated independently from one another. As illustrated in FIG. 4, individual jaw members are shaped such that, when operated in opposition, a cylindrical optical fiber preform may be self aligning between the jaw members. This may more clearly be seen in the top down view of exemplary carriage assembly 91 depicted in FIG. 5. Inside surfaces 94 and 96 of exemplary jaw members 98 and 100 define channels having sloping sides. When closed, the channels defined by inside surfaces 94, 96 contact and align the exemplary optical fiber preform 102 between jaw members 98, 100. Although FIG. 5 shows a generally U shaped channel for holding the optical fiber preform, the channels could be other shapes which may align the optical fiber preform between the jaw members, such as V shaped channels. The exemplary carriage assembly shown in FIG. 5 may be used as any one of carriage assemblies 48, 50. Jaw members 98, 100 are actuated by actuator 104 such that jaw members 98, 100 move toward or away from one another, depending upon the desire to secure or release exemplary optical fiber preform 102.

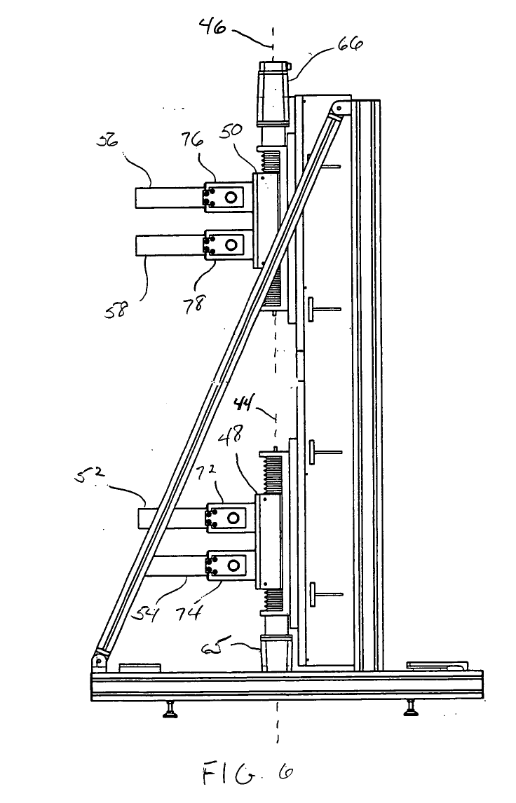

FIG. 6 is a side view of the embodiment of the optical fiber joining apparatus illustrated in FIGS. 1 and 4 showing the arrangement of carriages 48 and 50, carriage motors 65 and 66, actuators 72, 74, 76 and 78, and clamping member pairs 52, 54, 56 and 58.

Returning to FIG. 1, first and second electrode assemblies 108 and 110 are arranged in opposition to each other along axis 112. Preferably, axis 112 is orthagonal to the longitudinal axis 44 of first optical fiber perform 12. As previously discussed, first and second electrode assemblies 108 and 110 may alternatively be arranged in opposition to each other along axis 112 orthagonal to the longitudinal axis 46 of first optical fiber perform 14.

First and second electrode assemblies 108 and 110 comprise first and second electrodes 114 and 116 disposed within first and second electrode holders 118 and 120 respectively. First and second electrodes 114 and 116 are formed from an electrically conductive material resistant to high temperature and corrosion. Suitable electrodes may be composed of essentially pure tungsten, for example, or they may be comprised of various tungsten alloys or doped tungsten. Preferably, electrodes 114, 116 are comprised of thoriated tungsten (tungsten doped with thorium), zirconated tungsten (tungsten doped with zirconium), ceriated tungsten (tungsten doped with cerium), or lanthanated tungsten (tungsten doped with lanthanum); more preferably zirconated tungsten.

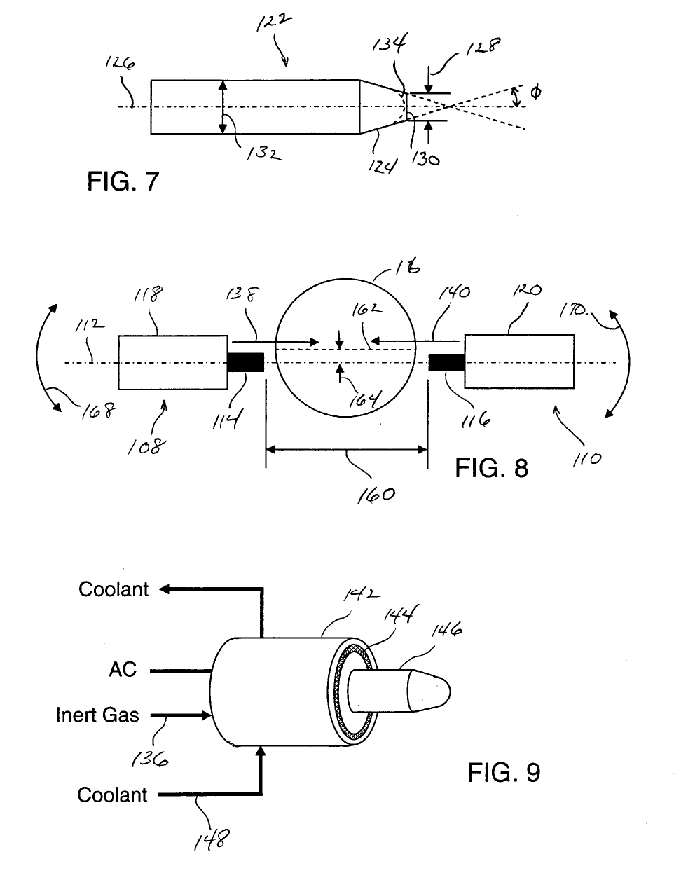

It is preferred that new electrodes be used for each join operation. To ensure proper electric arc formation, it is desirable that the tips of unused first and second electrodes 114 and 116 first be shaped such that the end of an electrode which serves to form an electric arc has initially a generally conical shape and a flattened tip, as shown in FIG. 7. As illustrated in FIG. 7, exemplary electrode 122 may be shaped, such as by grinding, at an end thereof to form a generally conical portion 124 which forms an angle φ less than about 30° with the longitudinal axis 126 of the electrode. Exemplary electrode 122 may be used as either of first or second electrode 114, 116.

The diameter 128 of flat portion 130 formed at the tip of exemplary electrode 122 adjacent conical portion 124 is preferably determined based upon the expected current flow. If the current flow is too low for a given diameter, the end of the electrode will not form a rounded, or ball-shaped tip as the electrode is heated. With a high current flow for a given diameter, the end of the electrode melts away. Generally, a diameter 128 of flat portion 130 approximately one third the overall diameter 132 of the electrode has been found to be satisfactory. A suitable electrode diameter 132 which may be used is preferably greater than about 0.15 inches (0.38 cm); more preferably greater than about 0.18 inches (0.46 cm); and most preferably at least about 0.25 inches (0.64 cm). After forming first and second electrodes 114, 116 to the appropriate shape, an electric arc may be formed between first and second electrodes 114, 116 preferably at a current of between about 100 and 200 amps until a suitable rounded tip, or ball is formed at the end of each electrode, as shown by dotted line 134 in FIG. 7. When ball 134 has been formed at the end of an electrode, the electrode has been prepared for use in joining optical fiber preforms.

Again referring to FIG. 1, an inert gas 136 is preferably flowed between the electrodes. Preferably, the inert gas is flowed to electrode holders 118 and 120 from one or more sources (not shown) in fluid communication with electrode holders 118 and 120, with the inert gas subsequently flowing from the electrode holders in a direction generally parallel to axis 112 and between first and second electrodes 114, 116. Suitable inert gases include, but are not limited to helium, argon and nitrogen, and combinations thereof. Preferably, two inert gas streams flow in opposition as indicated by arrows 138 and 140 in FIG. 8, a first gas stream 138 originating proximate first electrode 114 and flowing toward second electrode 116, and a second gas stream 140 originating proximate second electrode 116 and flowing toward first electrode 114. Preferably, first and second inert gas streams 138, 140 flow from an annular nozzle within each electrode holder 118, 120 disposed concentrically about the respective first and second electrodes 114, 116. Such an arrangement is illustrated by the exemplary electrode holder 142 of FIG. 9 showing annular nozzle 144 disposed concentrically about electrode 146. Exemplary electrode holder 142 may be used as either of first or second electrode holder 118, 120. It is desirable that the inert gas flowing from electrode holder 118, 120 be laminar. To aid in maintaining a generally laminar flow, inert gas 136 is preferably supplied to electrode holders 118 and 120 at a pressure of less than about 25 psi; more preferably less than about 20 psi; and most preferably about 10 psi. It is also preferable that first and second electrode holders 118, 120 be cooled. Cooling can be accomplished, for example, by flowing a coolant 148, such as water, through one or more passages (not shown) within the interior of each electrode holder 118, 120.

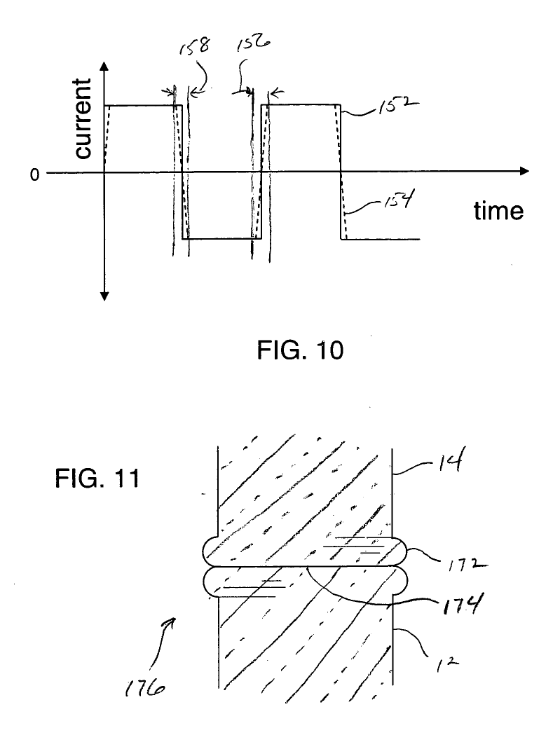

Returning to FIG. 1, electrodes 114, 116 are in electrical communication with power supply 150. Preferably, power supply 150 is capable of producing an alternating current having a substantially square waveform. As shown in FIG. 10, a perfect square waveform having instantaneous rise and fall times, as indicated by waveform 152, may not be practically achieved, as the current produced by the electrical power supply may have finite rise and fall times, as evidenced by the waveform depicted by dotted line 154. By rise and fall times what is meant is the time required for the waveform to rise from a minimum value to a maximum value, in the case of rise time 156, and the time it takes for the waveform to fall from a maximum value to a minimum value with regard to fall time 158. Also, there may be some rounding to the corners of the waveform. Preferably the working voltage, i.e. the voltage across electrodes 114, 116 after initiation of the electric arc is less than about 100 volts; more preferably less than about 70 volts; and most preferably between about 30 volts and 70 volts. The waveform produced by power supply 150 preferably has a frequency of about 40 Hz; more preferably at least about 100 Hz; even more preferably at least about 400 Hz; and most preferably at least about 1000 Hz.

When the electric arc has been established between first and second electrodes 114, 116, the electrodes are separated to a predetermined position wherein the tip of the first electrode is separated from the tip of the second electrode by a distance suitable for the diameter of the optical fiber preforms to be joined. For the purposes of further discussion, the distance 160 between the tip of the first electrode 114 and the tip of the second electrode 116 as indicated in FIG. 8 will hereinafter be referred to as the arc length. Preferably, the arc length 160 is at least about 1 inch (2.54 cm), more preferably at least about 3 inches (7.62 cm); more preferably still at least about 5 inches. In some cases an arc length of at least about 7 inches (17.78 cm) may be desirable, such as when very large preforms are to be joined. The current flowing between first and second electrodes 114, 116 when the first and second electrodes have reached their predetermined separation after initiation of an electric arc is preferably at least about 200 amps; more preferably at least about 400 amps; and most preferably at least about 500 amps. Preferably, the electric arc extends along a diameter 162 of opposing endface 16; more preferably, the electric arc is offset such that the electric arc extends across a chord of opposing endface 16 parallel to a diameter of the endface, such as diameter 162. Offset 164 between axis 112 and diameter 162 is preferably less than about 20 mm, more preferably less than about 15 mm.

Once the electric arc between first and second electrodes 114 and 116 is stable, first and second optical fiber preforms 12, 14 are moved in a direction parallel to the longitudinal axis 44 of first optical fiber perform 12 until gap 64 between opposing endfaces 16, 18 is sufficiently narrowed. Either the first or the second optical fiber preform may be moved, or both the first and the second optical fiber preforms may be moved. A narrower gap 64 between opposing endfaces 16, 18 results in greater stabilization of the electric arc and increased heat transfer between the electric arc and opposing endfaces 16, 18. However, the width of gap 64 must be balanced against the increased electrical resistance between the electrodes and the larger voltage required to overcome that resistance. It is preferable that power supply 150 be capable of supplying a continuous range of voltages. Preferably, gap 64 is less than about 10 mm; more preferably less than about 8 mm; and most preferably about 6 mm. Power supply 150 is controlled by controller 166. Controller 166 is preferably capable of controlling, inter alia, the voltage of the power supply, and the frequency and phase of the supplied waveform.

With an electric arc extending through gap 64 between opposing endfaces 16, 18 a relative motion is produced between first and second optical fiber preforms 12, 14 and the electric arc. This may be accomplished, for example, by rotating first and second electrode assemblies 108, 110 circumferentially about gap 64 as indicated by double arrows 168 and 170 in FIG. 8, preferably while maintaining a constant arc length 160. This may easily be accomplished by mounting electrode assemblies 108 and 110 on a rotatable table and connecting power supply 150 to electrodes 114, 116 through slip rings, as is known in the art. Alternatively, electrodes 114, 116 may be oscillated circumferentially about gap 64 such that only a partial rotation of the first and second electrodes about gap 64 is performed. Preferably, a rotation of first and second electrodes 114, 116 about gap 64 of at least about 180 degrees is performed. To ensure uniform heating of opposing endfaces 16, 18 it may also be desirable that the electric arc be translated across the opposing endfaces. Translation of the electric arc may be accomplished by translating first and second electrode assemblies 108, 110 along a plane generally parallel to the circumferential edge, as exemplified by edge 36 in FIG. 3, of opposing endface 16 or opposing endface 18.

The high temperature resulting from the electric arc heats opposing endfaces 16, 18 of first and second optical fiber preforms 12, 14. Preferably, opposing endfaces 16,18 are heated to at least their respective softening temperatures. When the opposing endfaces 16, 18 of first and second optical fiber preforms 12, 14 have been sufficiently heated, the electric arc is moved to a position outside gap 64 between first and second optical fiber performs 12 and 14, and first and second optical fiber preforms 12, 14 are moved together so as to contact opposing endfaces 16 and 18 thereby joining first and second optical fiber preforms 12, 14 to form an elongated optical fiber preform. Alternatively, the electric arc may be extinguished prior to joining first and second optical fiber preforms 12, 14. Either the first or the second optical fiber preform may be moved, or both the first and the second optical fiber preform may be moved. To ensure sufficient contact between opposing endfaces 16, 18, it is desirable that a predetermined amount of over travel is accomplished when joining first and second optical fiber preforms 12, 14. The amount of over travel is preferably at least about 1 mm; more preferably at least about 2 mm. In some cases an over travel of up to 3 mm may be required. By over travel what is meant is moving the optical fiber preforms 12, 14 a predetermined distance along an axis parallel to axis 44 beyond the point at which opposing endfaces 16 and 18 come into contact. The amount of over travel depends on such factors as preform diameter and the center portion height 34 on the respective opposing endfaces of the optical fiber preforms. For example, optical fiber preforms having a greater amount of center portion height at the opposing endfaces will require increased over travel, i.e. the flatter the opposing endfaces, the less over travel which may be required.

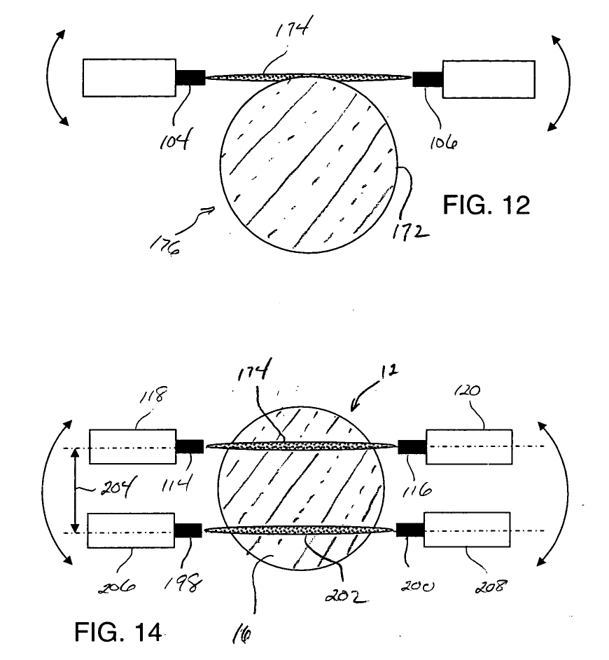

While the over travel which is performed during the step of contacting the first and second optical fiber preforms may ensure good contact between the opposing endfaces, it may also cause a ridge of glass 172 to be formed circumferentially at the joint, or interface 174, between the first and second optical fiber performs 12 and 14 as shown in FIG. 11. This ridge of glass 172 may be smoothed by moving electric arc 174 to a location tangent to glass ridge 172, as best illustrated by FIG. 12, and rotating the electric arc about the circumference of the joined first and second optical fiber preforms at glass ridge 172. If the electrode configuration is such that a complete rotation of electrodes 114, 116, and therefore electric arc 174 may be accomplished, for example if slip rings are employed for connecting power supply 150 to first and second electrodes 114, 116, the electric arc may be rotated continuously is a single direction to smooth glass ridge 172. It may be desirable to rotate the electric arc in an oscillatory fashion. Such might be the case if, for example, the electrodes are connected to power supply 150 by cables. Alternatively, the joined optical fiber preform 176 may be rotated while electric arc 172 is maintained in a stationary position tangent to the joined optical fiber preforms at glass ridge 172.

Once first and second optical fiber preforms 12, 14 have been joined and preferably smoothed, the joined optical fiber preform 176 may be formed into an optical fiber by using conventional drawing techniques wherein the joined optical fiber preform 176 is heated by a furnace and drawn into an optical fiber. Advantageously, the method according to the present invention may be practiced during the draw process wherein optical fiber preforms are continuously joined to a preceding optical fiber preform from which optical fiber is being drawn. In this manner, the draw process may be carried out continuously. For example, a first optical fiber preform may be lowered into a conventional draw furnace and an optical fiber drawn therefrom. A second optical fiber preform may be joined to the first optical preform in a manner according to the present invention. When the joined optical fiber preform has been consumed to a predetermined remainder, a subsequent optical fiber preform, which in the terminology of the present invention becomes the new second optical fiber preform, may then be joined to the remainder of the prior joined optical fiber preform, which becomes the new first optical fiber preform, and so on for as long as it is desired to continue joining optical fiber preforms.

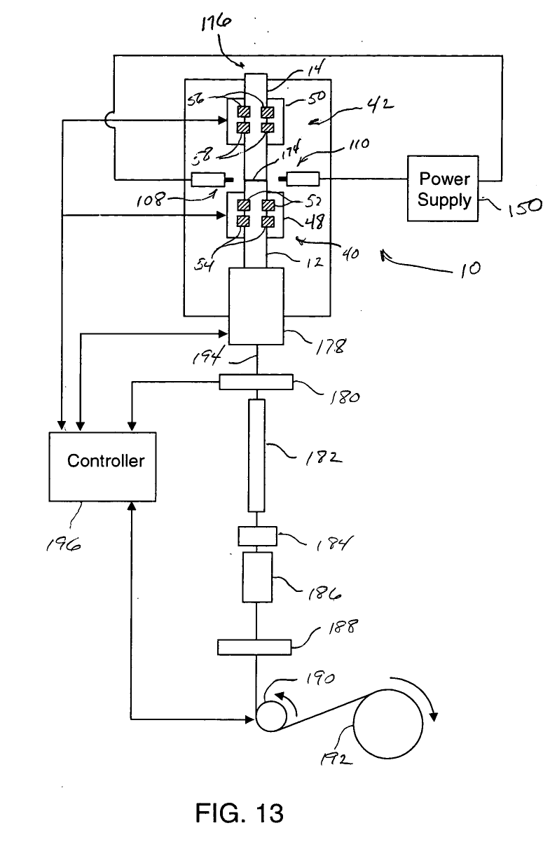

Referring to FIG. 13, a conventional optical fiber draw tower typically comprises a draw furnace 178, a device 180 for measuring the diameter of the uncoated optical fiber drawn from the optical fiber preform, a device 182 for cooling the drawn optical fiber, a coating apparatus 184 for applying a protective coating to the optical fiber, an irradiation device 186 for curing the protective coating, a device 188 for measuring the diameter of the coated optical fiber, a tractor device 190 for pulling the optical fiber from the optical fiber preform, and a take-up spool 192 for winding the optical fiber as it is drawn.

An optical fiber draw tower according to the embodiment depicted in FIG. 13 also comprises the apparatus generally indicated by numeral 10 for joining optical fiber preforms as described previously.

Referring to FIGS. 1 and 13, first optical fiber preform 12 is held by clamping member pairs 52 and 54 and lowered by carriage assembly 40 into draw furnace 178 wherein the tip of first optical fiber perform 12 is heated by draw furnace 178 until the tip softens and drops, pulling a filament of glass 194 (i.e. the optical fiber) behind it. Optical fiber 194 is threaded through glass diameter measurement device 180, cooling device 182, optical fiber coating device 184, curing device 186, coated optical fiber diameter measuring device 188 and optical fiber tractor 190, and attached to take-up spool 192 wherein a motor (not shown) rotates take-up spool 192 to wind optical fiber (glass filament) 194 onto spool 192. A controller 196 monitors various predetermined draw parameters by way of sensors (not shown) which send signals to controller 196 representative of the various draw parameters. For example, a signal representative of the optical fiber draw speed (tractor speed), the optical fiber uncoated diameter, the draw furnace temperature, and/or the optical fiber preform downfeed rate may be sent to controller 196. Controller 196 also provides control signals to certain devices. For example, controller 196 may send a signal to increase or decrease the draw rate of the optical fiber, or a signal to increase or decrease the draw furnace temperature or increase or decrease the optical fiber downfeed rate.

As optical fiber is drawn from first optical fiber perform 12, second optical fiber preform 14 is mounted to carriage 50 by clamping member pairs 56 and 58, and aligned with first optical fiber perform 12. Preferably, second optical fiber preform 14 is aligned such that the core of second optical fiber preform 14 is substantially aligned with the core of first optical fiber preform 12. Ideally, longitudinal axis 46 of second optical fiber preform 14 is aligned with longitudinal axis 46 of first optical fiber preform 12 to form a single common longitudinal axis. Second carriage assembly 42 is moved to lower second optical fiber perform 14 until a gap 64 exists between opposing endfaces 16 and 18. First and second electrode assemblies 108 and 110 are moved radially inward to a point wherein an electric arc is initiated between first and second electrodes 114 and 116. Electrode assemblies 108 and 110 are then withdrawn until a predetermined arc length 160 has been established. The predetermined arc length 160 should be greater than the largest diameter of first and second optical fiber preforms 12 and 14. First and second optical fiber preforms 12, 14 are then moved until gap 64 between opposing endfaces 16 and 18 is suitably narrowed. Preferably, gap 64 after narrowing is less than about 10 mm; more preferably less than about 8 mm; and most preferably less than about 6 mm. First and second electrode assemblies 108 and 110 may then be oscillated about longitudinal axis 44 of first optical fiber preform 12 such that the electric arc transects gap 64 between the opposing endfaces 16, 18 and heats the endfaces. When opposing endfaces 16, 18 have been heated for a time sufficient to soften the endfaces, the electric arc is removed from between opposing endfaces 16, 18. Preferably opposing endfaces 16 and 18 are heated for a period from about 30 seconds to 540 seconds. The amount of time is dependent primarily upon the arc power used and the diameter of the first and second optical fiber preforms. First and second optical fiber preforms 12, 14 are moved together such that opposing endfaces 16 and 18 contact, thereby joining the optical fiber preforms to form elongated optical fiber preform 176.

As elongated preform 176 is lowered into draw furnace 178, clamping member pairs 52 and 54 are released from the elongated optical fiber preform 176 and carriage assembly 40 moves upward to a position proximate carriage assembly 42. Clamping member pairs 52, 54 are then activated to re-clamp elongated optical preform 176 at an upper portion thereof. Clamping member pairs 56 and 58 are released from elongated optical fiber preform 176, and carriage assembly 42 moves upward. A new optical fiber preform having first and second endfaces is inserted into clamping member pairs 56, 58 which are then clamped to a new optical fiber preform. The new optical fiber preform is lowered by carriage assembly 42 and aligned with elongated optical fiber preform 176. Preferably, the first and second ends of the new optical fiber preform have been prepared to have the appropriate geometry, i.e. having a beveled edge, rounded endface, or otherwise raised center portion. At this time the elongated optical fiber preform 176 is designated as first optical fiber preform 12 and the new optical fiber preform is designated second optical fiber preform 14, and the process described supra repeats itself.

In another embodiment according to the present invention, as shown in FIG. 14, a plurality of first and second opposing electrodes 114, 116 and 198, 200, arranged in pairs, each electrode pair having a first and second electrode, are utilized to form a plurality of electric arcs 174, 202 between the first and second electrodes of each electrode pair, the plurality of opposing first and second electrode pairs being generally parallel to one another. The plurality of electric arcs may advantageously heat the opposing endfaces of the first and second optical fiber preforms more uniformly than a single electric arc. To maintain the stability of the plurality of electric arcs, it is preferable that the electric arcs be separated from each other by at least 1 inch (2.54 cm) along an axis between each pair of opposing first and second electrodes, hereinafter referred to as arc separation 204; most preferably at least about 2 inches (5.08 cm). As in the previous embodiment, electrode holders 118, 120, 206 and 208 are preferably supplied with an inert gas and a coolant. In addition, electrodes 114, 116, 198 and 200 are supplied with an electric current. Preferably, the electric current has an alternating, substantially square waveform. Also as in the previous embodiment, an inert gas is flowed between the electrodes. Preferably, two counter flowing inert gas streams are formed between electrodes 114 and 116, and between electrodes 198 and 200, respectively. Because the current flow contained within each of the plurality of electric arcs 174, 202 generates a significant electromagnetic field which may interact with adjacent electric arcs, tuning of the power supply to each pair of first and second electrodes may be necessary. It is therefore preferable that the frequency of the current supplied to each pair of first and second electrodes be independently variable. Preferably, the frequency supplied to one pair of first and second electrodes is one half the frequency supplied to an adjacent pair of first and second electrodes. Preferably the frequency supplied to one pair of first and second electrodes is phase locked to the frequency supplied to an adjacent pair of first and second electrodes.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

### EXAMPLE 1

First and second optical fiber preforms, each having a diameter of approximately 2.75 inches, were secured by clamping member pairs on separate carriages and aligned such that the longitudinal axis of each preform was aligned to a common longitudinal axis, with a gap between the opposing endfaces. First and second electrode holders containing first and second thoriated tungsten electrodes, respectively, were placed on a plane along an axis orthogonal to the common longitudinal axis of the first and second optical fiber preforms. The electrode holders containing the electrodes were supplied with a current having a square waveform. The working voltage between the electrodes was approximately 55 volts.

The electrodes where brought sufficiently close such that an electric arc was formed between the first and second electrodes, after which the first and second electrode holders and their respective electrodes were withdrawn until the arc length was approximately 4 inches (10.16 cm). Each electrode holder was supplied with argon gas at a pressure of about 10 psi. The first and second optical fiber preforms were moved along their common longitudinal axis until the gap separating the opposing endfaces was reduced to about 10 mm and the electrode holders, and their respective electrodes, were oscillated about the common longitudinal axis at a rotational speed of about 10 rpm. The opposing endfaces of the first and second optical fiber preforms were heated by the plasma arc for approximately 300 seconds. At the end of the heating period, the electric arc was moved to a position tangent to the outside surfaces of the first and second optical fiber preforms, and the first and second optical fiber preforms were translated toward each other along their common longitudinal axis a distance of about 6.5 mm each (an over travel of approximately 3 mm) and successfully joined.

### EXAMPLE 2

First and second optical fiber preforms, each having a diameter of approximately 4.5 inches (11.43 cm), were secured by clamping member pairs on separate carriages and aligned along a common longitudinal axis, with a gap between the opposing endfaces as in the previous example. The opposing endfaces were flat. Two pairs of first and second electrode holders containing first and second electrodes, respectively, were mounted on a table capable of rotation and/or oscillation and in a plane orthogonal to the common longitudinal axis of the first and second optical fiber preforms. An electric arc was formed between the first and second electrodes of each pair of first and second electrodes. Both pairs of first and second electrodes were supplied by independent power supplies, inert gas streams and cooling water. The inert gas flow to each electrode holder was 10 psi. The inert gas flowed to each electrode holder was 100% argon. An electric arc was initiated between a first pair of first and second electrodes and allowed to stabilize for approximately 30 seconds, after which an electric arc was initiated between the second pair of first and second electrodes. The arc separation between first and second electrode pairs was 1.69 inches (4.29 cm). The arc length was 4.25 inches (10.80 cm) for each pair of first and second electrodes. The first and second optical fiber preforms were translated in a direction parallel to their common longitudinal axis until a gap of approximately 10 mm separated the opposing endfaces of the first and second optical fiber preforms. The opposing endfaces of the first and second optical fiber preforms were heated by the two electric arcs for an initial period of 30 seconds as the electrode pairs were oscillated about the common longitudinal axis. The current being supplied to each pair of first and second electrode pair was about 185 amps. The frequency of the square wave supplied to the first electrode pair was 195 Hz and the frequency of the square wave supplied to the second electrode pair was 390 Hz. After the initial heating period, the first and second optical fiber preforms were further translated such that the gap between the opposing endfaces was reduced to 8.5 mm. The current supplied to each electrode pair was reduced to 184 amps as a result of the reduction in the gap between the opposing endfaces. The first and second optical fiber preform opposing endfaces were heated at the new gap width (8.5 mm) for an additional 270 seconds. At the end of the final heating cycle of 270 seconds, the electric arcs were translated outside of the gap between the first and second optical fiber preforms, and the first and second optical fiber preforms were moved toward each other to contact the opposing endfaces. The amount of over travel was approximately 1 mm.

1. A method of joining optical fiber preforms comprising:
aligning first and second optical fiber preforms, the first and second optical fiber preforms each having an opposing endface;
forming an electric arc extending between first and second electrodes, the electric arc extending through a gap between the opposing endfaces;
moving the first and second optical fiber preforms together so as to contact the opposing endfaces and join the first and second optical fiber preforms.

2. The method according to claim 1 wherein the first and second electrodes comprise tungsten and a material selected from the group consisting of thorium, zirconium, cerium and lanthanum.

3. The method according to claim 1 wherein an inert gas is flowed between the first and second electrodes.

4. The method according to claim 3 wherein the flow of inert gas comprises at least two gas streams flowing in opposition to each other.

5. The method according to claim 1 wherein the electric arc is formed by supplying an alternating current to the first and second electrodes.

6. The method according to claim 5 wherein the alternating current has a substantially square waveform.

7. The method according to claim 1 further comprising the step of providing relative motion between the first and second electrodes and the first and second performs during heating.

8. The method according to claim 7 wherein the relative motion comprises rotating the first and second electrodes about a longitudinal axis of the first optical fiber preform.

9. The method according to claim 1 wherein the electric arc has a length of at least about 1 inch.

10. The method according to claim 9 wherein the electric arc has a length of at least about 3 inches.

11. The method according to claim 9 wherein the electric arc length is at least about 5 inches.

12. The method according to claim 1 wherein the gap between the opposing endfaces during heating is less than about 10 mm.

13. The method according to claim 1 wherein the forming step comprises forming a plurality of electric arcs extending between a plurality of first and second electrodes, the plurality of first and second electrodes arranged in pairs wherein each pair comprises a first and second electrode.

14. The method according to claim 13 wherein a frequency of an alternating current supplied to a first pair of first and second electrodes is one half the frequency of the alternating current supplied to an adjacent pair of first and second electrodes.

15. The method according to claim 14 wherein the alternating current supplied to the first pair of first and second electrodes is phase locked to the alternating current supplied to the adjacent pair of first and second electrodes.

16. The method according to claim 1 further comprising drawing the joined optical fiber preform into an optical fiber.

17. An apparatus for joining optical fiber preforms comprising:
a first and second electrode, the electrodes being spaced apart by a distance of at least about 1 inch;
an electrical power supply in electrical communication with the first and second opposing electrodes for supplying a current to the first and second electrodes.

18. The apparatus according to claim 17 wherein the power supply is capable of providing an alternating current having a substantially square waveform.

19. The apparatus according to claim 17 comprising a plurality of first and second opposing electrodes.

20. An optical fiber draw tower comprising the apparatus of claim 17.
